(19) United States
(12) Patent Application Publication
(10) Pub. No.: US 2022/0269524 A1
(43) Pub. Date: Aug. 25, 2022

(54) METHOD AND APPARATUS FOR SECURE DATA ACCESS DURING MACHINE LEARNING TRAINING

(71) Applicants: Volodimir Burlik, Coquitlam (CA); George Medvedev, Vancouver (CA); Sergei Nesterenko, Bellevue, WA (US)

(72) Inventors: Volodimir Burlik, Coquitlam (CA); George Medvedev, Vancouver (CA); Sergei Nesterenko, Bellevue, WA (US)

(21) Appl. No.: 17/579,849

(22) Filed: Jan. 20, 2022

Related U.S. Application Data
(60) Provisional application No. 63/151,171, filed on Feb. 19, 2021.

(51) Int. Cl. G06F 9/455; G06N 20/00; G06K 9/62; H04L 9/40

(52) U.S. Cl. CPC G06F 9/45558; G06N 20/00; G06K 9/6256; H04L 63/0281; H04L 63/10; G06F 2009/45579; G06F 2009/45595; G06F 2009/45562; G06F 2009/45587

(57) ABSTRACT

At least a method and an apparatus are presented for secure access of shared data for machine learning training. In one embodiment, a virtual machine is created based on a virtual machine environment type input, wherein the virtual machine permits access to one or more training data sets for training a machine learning system if the virtual machine environment type input indicates access to data enabled mode, and wherein the virtual machine prohibits the access to the one or more training data sets for training the machine learning system if the virtual machine environment type input indicates access to data disabled mode.

### CROSS-REFERENCE TO RELATED APPLICATION

This application claims the priority and all the benefits of U.S. Provisional Application No. 63/151,171 filed on Feb. 19, 2021, the content of which is hereby incorporated by reference in its entirety.

### TECHNICAL FIELD

The present embodiments generally relate to improvements and practical applications of computing and networking technologies, and more particularly, to apparatuses and/or methods of secure access and protection of data sets during training of machine learning models, algorithms and/or apparatuses.

### BACKGROUND

Machine learning opens tremendous opportunities to solve a variety scientific and practical problems in many areas of human activities. Still, its application is limited to a large degree by the fact that data used for training cannot be easily shared due to the reasons of privacy and data protection. Facilitating access to data for machine learning is a top priority for data scientists.

An existing solution to access relevant machine learning datasets is to request security clearance from the data governing organizations. This process is often time-consuming and cumbersome. It is often impossible to accomplish due to the risks of compromising security and privacy of proprietary datasets owned by individuals and institutions. The approach described here helps to resolve such issues by providing a uniform solution giving opportunities for interested parties to securely share datasets enabling development of machine learning applications without compromise.

Accordingly, needs exist in the field for a system, an apparatus and/or a method to provide secure centralized storage and secure access to third party owned proprietary data sets outside of the public domain, particularly for use in machine learning training and applications.

### SUMMARY

The present embodiments provide an exemplary method, apparatus and/or system to facilitate secure access to protected data for training of machine learning models. The proposed approach embodies a separation of machine learning training algorithms and the training datasets. One exemplary solution comprises separate entities in a trusted environment to accommodate a secure, end to end process of model training while disabling public Internet connection to prevent transfer of data outside of the trusted environment is described. Major entities of the present disclosure include on one side clients/end users, who are the owners of the machine learning algorithms, and a Trusted Development Environment (TDE) provider on the other side, acting as a secure proxy to encrypt and govern access to protected data. TDE provider creates a development environment with a public API (Application Programming Interface) capable of accessing data solely for the purpose of machine learning models training. This runtime API is utilized by client's algorithms cannot be used to capture and transfer any data to the client-side. In one embodiment, the TDE is provided via one or more Virtual Machines (VMs).

The present embodiments provide practical application and make improvements to existing computing and communications technologies and provide a practical solution to problem of gaining secure access to protected data owned by numerous institutions and organisations. Disclosed exemplary embodiments enable interested parties to have equal opportunities to make use of and collect intelligence from available but proprietary historical datasets to solve outstanding scientific and practical problems using machine learning algorithms.

### BRIEF DESCRIPTION OF THE DRAWINGS

FIG. 1 illustrates a block diagram of an embodiment of a development VM (Virtual Machine) environment.

FIG. 2 illustrates a block diagram of an embodiment of a data augmentation VM environment.

FIG. 3 illustrates a block diagram of an embodiment of a secure training VM environment.

FIG. 4 illustrates a block diagram of an embodiment of a production deployment VM environment.

FIG. 5 illustrates a block diagram of an embodiment of a prediction VM environment.

FIG. 6 illustrates an exemplary process according to the present embodiments.

FIG. 7 illustrates an exemplary system according to the present embodiments.

### DETAILED DESCRIPTION

The present disclosure is to be considered as an exemplification of the present principles and is not intended to limit the present disclosure to the specific embodiments illustrated by the figures or description below. The present disclosure will now be described by referencing the appended figures representing various embodiments. The present disclosure provides a system and/or a method to securely access third party owned proprietary (protected) data for use in the training of machine learning algorithms or models. The present disclosure embodies the separation of machine learning training algorithms and training data sets, as well as separation of entities participating and executing a secure end-to-end process of model training in a trusted environment utilizing a practical and novel application of computing and communications technologies.

The present disclosure comprises major components such as, e.g., Clients, a Trusted Development Environment (TDE) and a Trusted Prediction Environment (TPE) where clients are owners of the machine learning algorithms/apparatuses.

Trusted Development Environment (TDE) providers act as secure proxies that govern access to protected data sets. A client entity's training algorithm and protected data used for training are hosted within a Trusted Development Environment. The TDE providers deliver a development environment with a public API capable of accessing the data solely for the purpose of model training. This runtime API is utilized by the client's algorithms programmed in scripts and cannot be used to transfer data back to the client-side. In addition, TDE also provides mechanisms arbitrarily encoding metadata and actual values of the dataset descriptors into randomized universally unique identifiers (UUIDs) to prevent privacy compromise.

Trusted Prediction Environment (TPE) is also used to deploy trained models in production VM instance(s).

Various embodiments according to the present principles may be implemented as a Software as a Service (SaaS) in a client-server architecture. Each major component may contain various modules/subcomponents. A high-level description of each main component and its modules/subcomponents is provided below:

1. Clients

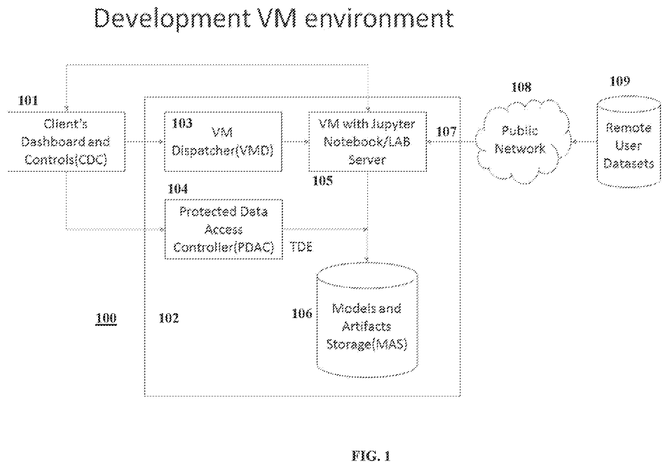

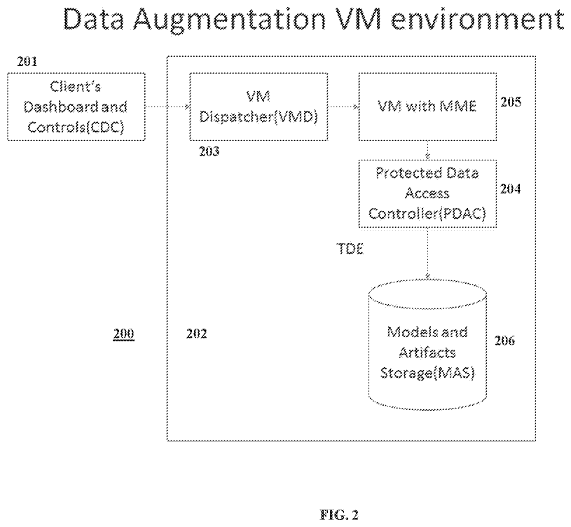

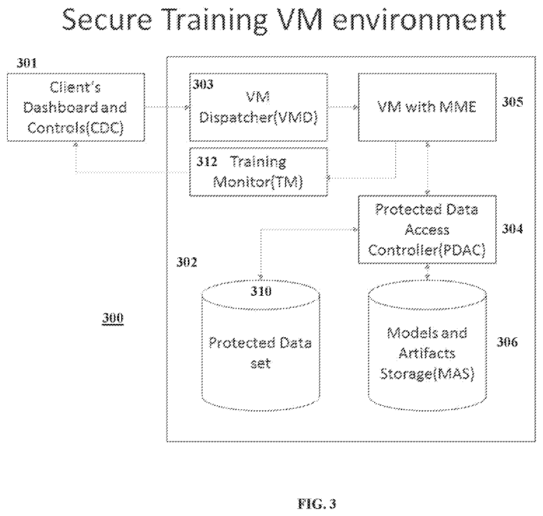

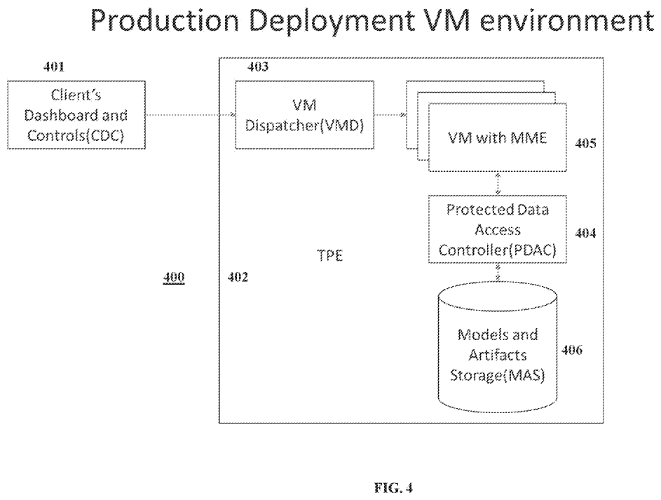

Clients are owners of machine learning algorithms/apparatuses and may comprise:
1.1 Clients Dashboard and Controls (CDC, 101 in FIG. 1; 201 in FIG. 2; 301 in FIG. 3; 401 in FIG. 4) in a client web interface:
   User project management:
      Create a new or open existing project
      Protected datasets browser
      Analytics
      Etc.
   Create VM (virtual machine) configurations for development, data augmentation, secure training, production deployment
   Controls saving project, starting/stopping training
   Training progress monitor, model performance plots; and
   Etc.
1.2 Clients' applications with the REST API to access deployed model(s) in production
   End user application must implement the API to be able to send prediction requests and parse the results. A REST API (also known as RESTful API) is an application programming interface (API or web API) that conforms to the constraints of REST architectural style and allows for interaction with RESTful web services. REST stands for representational state transfer and was created by computer scientist Roy Fielding, and is well known in the art.

2. Trusted Development Environment (TDE, 102 in FIG. 1; 202 in FIG. 2; 302 in FIG. 3; 402 in FIG. 4)

Trusted Development Environment providers act as secure proxies governing client/user access such as, e.g., access to protected data sets and VM dispachers (e.g., 103 in FIG. 1; 203 in FIG. 2; 303 in FIG. 3; 403 in FIG. 4). A client entity's training algorithm and a protected set of data used for training are hosted within a Trusted Development Environment. The TDE providers facilitate a development environment with an API to enable access of protected data solely for the purpose of the model training. This runtime API is used by client's algorithms or scripts containing execution commands, for example, a “start” command to ‘start a new training process utilizing the protected data’, a “resume” command to “resume training process utilizing the protected data”. This runtime API cannot be used to transfer any secure data back to the client side as part of the secured access features of the present embodiments. That is, for example, the “start” or “resume” API commands will create a VM instance, which does not have or allow access to the Internet once the VM instance is created. Thus, there are no physical means to access or ‘steal’ the protected data. Once the execution of the VM instance is finished, access to the Internet may resume or not depending, e.g., on the state or type of the API command(s).

FIG. 1 illustrates a block diagram of an embodiment 100 including a trusted development environment TDE 102 implemented using virtual machines (VMs). TDE 102 adds an additional layer of protection for protected data by restricting public network (108) access (107) of a VM instance (105) in which a process is run. Upon receiving a client's request via a client's dashboard and controls (101) and runtime API as described above to execute a development, training or prediction process, a Virtual Machine dispatcher (103) within the TDE 102 spins off a new Virtual Machine instance (105) dedicated to run the requested process. TDE 102 then determines the type of operation running in the Virtual Machine instance and the nature of data sets used to determine whether the VM instance (105) would have a connection (107) to any public communication network (108), e.g., the Internet.

TDE 102 chooses between a public network access enabled mode and a public network access disabled mode for each VM instance.

In an exemplary embodiment, when a client/user issues a ‘development’ API command, TDE 102 creates a public network access enabled VM with an integrated development environment (IDE) fully accessible by the client/user over the Internet in order to perform the development (e.g., train, re-train, performance monitoring, and etc.) of their model(s). During such development, clients/users can use and freely access: a) unsecured subset of the protected dataset, dedicated solely for model development purpose, b) any additional client's datasets or publicly accessible datasets to compliment the development. The process of VMs allocation is well known in the art and may be provided by well-known cloud or software providers such as, e.g., Microsoft Azure, Amazon AWS, Google Cloud, or others.

In another exemplary embodiment, when a client/user issues, e.g., a “training”, “retraining”, “run data augmentation” command, TDE 102 creates VM(s) without an IDE. The VMs are also created with no Internet connection and/or Internet connection being prohibited. The VM(s) can run the process of model training, model retraining, or protected data augmentation process. Due to the fact that the VM(s) do not have access and/or is prohibited to access the Internet, data cannot be accessed or stolen. The artifacts (e.g., weights coefficients) of the model(s) training process are also considered protected data and stored securely in Model Artifact Storage (MAS). The decision on whether to share the artifacts obtained as a result of machine learning training process with the 3-d parties is solely at the discretion of the dataset owners. Not sharing training artifacts would add an extra level of security, preventing theoretical possibility of the reverse engineering of the artifacts.

In yet another embodiment, when a client/user issues a ‘deployment’ command for the already trained model(s), TDE 102 creates VM(s) without IDE. The VM's hosting Managed Model Executor (MME) loads the model(s) in prediction mode and becomes ready for serving client's application users requests over the public Internet via REST API.

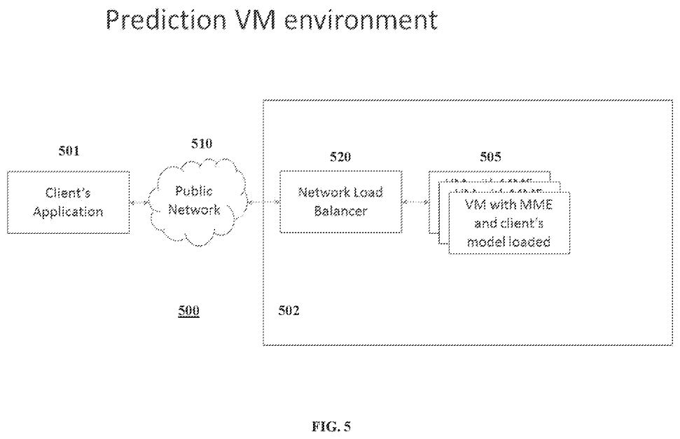

Accordingly, for example, public network access enabled mode is used during machine learning model development (FIG. 1) and, during the prediction process in production (FIG. 5). On the other hand, public network access is disabled in VM instances where the preparation, augmentation (FIG. 2) or feature extraction processes of the protected data take place, as well as during training (FIG. 3) and prediction (testing model performance) steps that involve the access to protected data. Virtual Machine instance with public network access disabled mode is aimed to safeguard data and information from being transferred outside of the Virtual Machine execution space and the TDE and to prevent any protected datasets from being tampered by entities outside of the TDE.

Additionally, other sub-entities/modules within the TDE may include:
2.1 Clients secure registry
   TDE maintains clients' registration information.
2.2 Clients' datasets subscription registry
   TDE keeps track of the approval process for each client requesting access to a specific dataset and existing contracts. All information associated with each sample and queried by the client's script is arbitrarily encoded by TDE. For example, the real names of organizations and departments, equipment, etc., are assigned with randomly generated UUID. The randomization happens at the time of subscription to each dataset as an additional security measure. For the machine learning algorithms, the real values of such information are irrelevant. Relevance only pertains to the fact that one name is different from another, so the training algorithm performs desired grouping.
2.3 Server side of the client's dashboard and controls
   TDE maintains corresponding server-side modules to process requests received from Clients Dashboard and Controls user interface described in Client's entities 1.1.
2.4 VM dispatcher (VMD, 103 in FIG. 1; 203 in FIG. 2; 303 in FIG. 3; 403 in FIG. 4)
   VM is an execution entity (computer and/or software module) supplied by the certified providers (for example, Microsoft Azure or Amazon AWS), or local data centers acting as a proxy for the data owners. TDE may comprise a Virtual Machine Dispatcher (VMD) which manages per project registration information and the lifecycle of the virtual machines. Specific services provided include allocation and termination of virtual machines and provisioning of user project data.
2.5 Protected Data Access Controller (PDAC, 104 in FIG. 1; 204 in FIG. 2; 304 in FIG. 3)
   TDE may comprise a Protected Data Access Controller (PDAC) that determines and governs secure read requests to protected data depending on the type of current VM environment (e.g., such as one or more of the VM environments shown in FIGS. 1 to 5). PDAC is accessed via TDE API. VM dispatcher (VMD) is capable of starting VM instances in two modes: (1) public network access enabled mode or (2) public network access disabled mode. In a public network access enabled mode in a VM environment, PDAC allows access to non-protected data including clients/users' own datasets (e.g., 109 in FIG. 1) while the VM instance maintains public network connection with a client. In a public network access disabled mode in another VM environment, PDAC allows running processes specified in a user's script to gain secure access to protected data while the VM instance does not have physical network connection to a client or any entity outside of the TDE via a public network, e.g., the Internet. In this manner, the runtime API utilized by the client's algorithms/scripts, which contain execution commands with respect to training, cannot be used to transfer any data back to the client side. This is due to the fact that physical network connection to any public network from the VM instance to the client interface is disabled, thus preventing any protected datasets to be tampered or/and transferred outside of the TDE.

TDE determines an appropriate VM type to run in a public network access enabled mode or a public network access disabled mode based upon the type of VM environment, characteristics of processes run, and security level of data sets required to run these processes. These different VM environments with different characteristics/processes are illustrated in FIG. 1 to FIG. 5. For example, a VM environment may be classified as a Development VM Environment (e.g., FIG. 1), a Data Augmentation VM Environment (e.g., FIG. 2), a Secure Training Environment (e.g., FIG. 3), and a Production Deployment Environment (e.g., FIG. 4), and a Prediction VM environment (e.g., FIG. 5).

As noted above, FIG. 1 shows an example of a development VM environment 100. In a development VM environment, clients/users write training model code, run data preparation, augmentation, feature extraction, training, and verification of the model. Users can run data preparation, training, and prediction phases as a part of the development process within Jupyter Notebook/Lab (105) user interface within the TDE 102. PDAC 104 grants access to non-secured data subsets (109) only and access to protected data (not shown in FIG. 1) is prohibited, but public network access (107, 108) is permitted or enabled. Thus, the running processes (105) can only make use of non-secure data sets (109) in the public domain or residing in remote locations, or users' owned datasets (109) uploaded by the client to the development environment and stored in a dedicated user database accessible by PDAC (104).

FIG. 2 shows an example of a data augmentation development VM environment 200. In a data augmentation VM environment 200, users prepare data for training. For example, it may be useful to split datasets into training, validation, and test subsets. Users may also perform data augmentation which involves creating additional samples by slightly modifying original ones, leading to more robust training outcome. In some cases, such as with audio data samples, data preparation may include features extraction steps which often take up considerable processing time. It is desirable to perform such steps separately and in advance and store the resulting final features and subsets that would be used in future training processes in order to save time and resources on future allocated VM instances. PDAC 204 enables access to protected data sets for data training purposes (this is the same training/dataset access process as will be shown in and described in connection with FIG. 3, and therefore it is not shown in or described in connection with FIG. 2 to avoid redundancy). The resulting trained data sets are subsequently stored in designated secure storage in MAS 206 and can only be accessed by PDAC's protected data reader (as part of PDAC 204) and can only be used in a secure training VM environment (FIG. 3).

FIG. 3 shows an example of a secure training development VM environment 300. In a secure training VM environment 300, developed models (306) are trained using secured datasets (310). PDAC (304) enables access to protected datasets (310) and the secure storage MAS (306), while a VM instance created by the VM Dispatcher (303) has disabled Internet/public network connection (not shown). At the same time, a secure LAN connection the TDE proxy is maintained to solely monitor the training progress in form of visual graphs. This prevents any protected datasets to be tampered and transferred outside of the TDE.

FIG. 4 shows an example of a production deployment VM environment 400. A production deployment VM environment is used for prediction. In a production deployment VM environment 400, a Managed Model Executor (MME, 405) in TPE (402) is started, which launches an embedded HTTPS web server. The TPE server 402 waits for a user application's REST API prediction calls with supplied input data (for example, an image content) that needs to be predicted by the client's model. When a client's prediction request is received by the web server, the web server forwards the request to the client's model predict method and the returned prediction object (for example json object) is sent back in http response (see also Prediction VM environment description (FIG. 5)). The PDAC 404 disables access to protected data. This prevents any protected datasets to be tampered and transferred outside of the TPE 402. The VM 405 has enabled a physical connection to a public network to provide online prediction capabilities to the end user client applications via REST API. The prediction request API and the response parsing are developed by the client. For example, the client's API must provide a REST request to transfer an image content for prediction, while the end user application must be able to parse the response and interpret prediction results.

FIG. 5 illustrates a block diagram of an embodiment of a prediction VM environment 500, after the production deployment illustrated in FIG. 4. This prediction after deployment VM environment 500 will be further described in detail below.

2.6 Managed Model Executor (MME, 205 in FIG. 2; 305 in FIG. 3; 405 in FIG. 4; 505 in FIG. 5)

This component runs and manages:
Secure data augmentation process within the data augmentation VM environment (200 in FIG. 2).
Secure training process within a secure training VM environment (300 in FIG. 3).
Prediction in the production deployment VM environment (400 in FIG. 4; 500 in FIG. 5).
Collects and reports training statistics to client's dashboard.

2.7 Model and Artifact Storage (MME, 106 in FIG. 1; 206 in FIG. 2; 306 in FIG. 3; 406 in FIG. 4)
Secure users' models source code and artifacts storage.
Stores raw and preprocessed protected data sets.
Stores users' uploaded unprotected data sets.
Stores trained and augmented samples, caches, features, and model artifacts: training weight coefficient tensors.
Stores outcome of model training—weight coefficient tensors.

3. Trusted Prediction Environment (TPE)
3.1 Sub-entities within the TPE may include:
   3.1.1. VM dispatcher (VMD)
   See description in TDE.
   3.1.2. Model Artifact Storage (MAS)
   See description in TDE.
3.1.3 Network Load Balancer
   A load balancer is a device that acts as a reverse proxy and distributes network or application traffic across a number of production deployment VMs. Load balancers are used to increase capacity (concurrent users) and reliability of applications.

### Functional Description and Examples of Processing/Message Sequences

A Client View provides details of user interface input and processing steps involved on the client side. A Trusted Development Environment View provides an overview of user interface and processing steps on the server side.

### Processing/Message Sequence (Client's View):

1. Client is registered with the TDE machine learning service.

2. Client is presented with:
1. A list of available protected datasets with labeled (for supervised or semi supervised learning) or unlabeled (unsupervised learning) samples.
2. Full description of the dataset:
   1. Media type (imaging, audio, EEG, ECG, statistical data, etc.)
   2. Data format. Example:
      Image width: 800, height: 800, color channels: 3
      Audio clips: variable length, sampling rate: 8 KHz, channels: 2
   3. Labels description (types, masks, etc.). Example:
      Images dataset:
         1. Label types: textual representation: “Normal”, “Abnormal”.
         2. Mask: Image mask hiding unrelated image area, width: 800, height: 800, color channels: 1
      Audio dataset:
         1. Label types: textual representation: “Normal”, “Abnormal”.
         2. Label format: start time, end time in seconds
   4. Time of capture
   5. Arbitrarily encoded data origin:
      Organization name
      Department/unit name
      Equipment used to capture the data, etc.
3. Each dataset includes a small subset of data samples, which are non-secure and can be used for initial algorithm verification and machine learning model development purposes within TDE.

3. Client chooses the dataset(s) of interest via subscription mechanism.

4. Client chooses hardware requirements, for example, “a Development VM”, for a virtual machine (VM) instance with Development Terminal (DT). A Development Terminal is a workspace with an interface to upload or edit source code as well as to execute the source code within the boundaries of the VM.
1. VM is an execution entity (computer/software component) supplied by the certified providers (for example, Microsoft Azure) as well known in the art, or local data centers acting as a proxy for the data owners.
2. In the provided text editor client writes, edit or upload source code of the machine learning model.
3. Within the boundaries of the VM in the Trusted Development Environment, clients can run data preparation, training and prediction steps.

When a “Development VM Environment” is chosen, TDE automatically determines and configures the launched VM instance with “access to protected data is disabled” and “public network connection access enabled”, thus enabling operation in the VM environment to access and use non-secured data either stored in the MAS or from the public domain, as well as allowing any non-secure data to be returned to the client's side by TDE's provided API.

5. Client chooses the hardware requirements, for example, a “Data Augmentation VM Environment”, for virtual machine (VM) instance(s). When a “Data Augmentation VM Environment” is chosen, TDE automatically determines and configures the launched VM instance with “access to protected data enabled” and “public network connection access disabled”, to access protected data stored in MAS and to execute one or more of preparation, augmentation, and feature extraction processes on such protected data sets. This is an optional step.

6. Client chooses the hardware requirements, for example, a “Secure Training VM Environment”, for VM instance(s). When a “Data Augmentation VM Environment” is chosen, TDE automatically determines and configures the launched VM instance with “access to protected data enabled” and “public network connection access disabled” to accommodate the training process that uses protected data from step 5. VMs are allocated when the training process is launched.

7. Client chooses the hardware requirements, for example, a “Production Deployment VM Environment” for virtual machine (VM) instance(s). When a “Production Deployment VM Environment” is chosen, TDE automatically determines and configures the launched VM instance with “access to protected data disabled” and “public network connection access enabled” to accommodate the prediction process in production. VMs are allocated when the model is deployed in a production environment.

8. Clients opens a Development Terminal (DT) on TDE using secure https connection in the virtual machine from step 4 above.

9. Clients are given an option to start developing machine learning models from scratch within TDE or upload the existing ones.

10. Client develops machine learning model(s) with available non-secure data subset to ensure validity of the data processing pipeline for training and prediction processes in production corresponding to data format and geometry.

11. Clients optionally can upload their own data to TDE to be used in addition to subscribed protected data. In this case client's own datasets are kept separately within TDE.

12. Client runs data preparation using VM from step 5 above.

13. Client trains machine learning model(s) with the chosen secured dataset(s) using TDE API to access the protected data during training, validation, and test phases using VM from step 6 above.

14. Client decides on the criteria upon which the development is considered to be finished, and the machine learning model is ready for deployment in the production within TDE.

15. Client chooses to deploy the project in production using VM from step 7 above.

### Processing/Message Sequence (TDE View):

1. TDE gets client's register request and goes through approval process.

2. TDE gets client's login request.

3. TDE opens client's DT

4. TDE offers an option to create ‘new project’ with associated media type (Imaging, EEG, ECG, etc.) or open existing project.

5. TDE presents to the client available datasets associated with the project type.

6. TDE grants subscription request to chosen datasets (if not already granted for existing project).

7. TDE facilitates development process described in Message Sequence (Client side) 0.4-0.15

8. TDE executes a deployment procedure utilizing VM configuration for production environment specified in Message Sequence (Client side) 0.6

9. TDE allocates secure Uniform Resource Locator(s) (URL) for the client to be used in their application(s) as an access point(s) to the trained model.

10. When the model is finished training, the client queries TDE to launch Trusted Prediction Environment (TPE) which is used to deploy trained models in production VM instance(s). TPE supports the following functionality:
1. Login
2. Run prediction on a sample or a batch of samples
3. Logout

### Training Algorithm Processing Message Sequence—Client's Side

At runtime of the client's training algorithm (script), the following TDE functional API is available:
Obtaining a list of Universally Unique Identifiers (UUIDs) corresponding to each dataset the client has subscribed for.
Obtaining a list of samples' UUIDs comprising the dataset
Obtaining sample descriptor with arbitrarily encoded:
   Organization name
   Department/unit name
   Equipment used to capture the data
   etc.

This information is optionally used by the client's script to split datasets to training, validation, and test subsets. The information structure and content provided for each sample depends on the type of the dataset, which may vary. The client's training algorithms must be adjusted accordingly.

All the information associated with each sample and queried by the client's script is arbitrarily encoded by TDE. For example, the real names of organizations and departments, equipment, etc., are assigned with randomly generated UUID. The randomization happens at the time of subscription to each dataset as an additional security measure. For the machine learning algorithms, the real values of such information are irrelevant. Relevance only pertains to the fact that one name is different from another, so the training algorithm performs desired grouping.
Querying number of samples
Querying number of classes for classification models
Querying classes values
Opening a sample content for the purpose of:
   1. Augmentation (if needed)
   2. Feature vectors construction

### Training Algorithm Data Access Processing Sequence

TDE's main function is to ensure secure access to the protected datasets available to the training algorithm at runtime while prohibiting transfer of the data back to the client's side. To achieve this objective, TDE allocates training virtual machines with disabled public network access to entities outside of TDE, while maintaining local secure access to monitor training progress only.

1. Open dataset with UUID

2. Read a list of samples UUID

3. Read sample descriptor

4. Decide whether sample belongs to either training, validation, or test sets

5. Read a sample content

6. Run augmentation to produce additional samples (if desired)

7. Extract feature vectors from each augmented sample

8. Create batch from a number of features

9. Repeat process for the whole dataset

10. Resulting batches are ready to be used for training

When a client's script runs data preparation and/or training processes using VMs allocated in Client's view sequence steps 5 and 6, it is given access to a secure location(folder) of MAS which is only available in secured mode where public network access from the VM instance to entities outside of the TDE is disabled.

### Prediction Data Processing/Message Sequence

The prediction process is happening within the Trusted Prediction Environment (TPE).

1. Client launches their trained model instance(s) within TPE according VM requirements outlined in Message Sequence (Client's view) step 7

2. Client's application sends data (for example: image or a batch of images) over https connection to the model via REST API using supplied public URL

3. Model runs either single image prediction or a batch prediction

4. Resulting list of prediction objects are returned to the user application. Each prediction object is comprised of:
1. prediction UUID
2. predicted data (label(s), or regression result(s))
3. predicted data probability
4. inference time

As noted above, FIG. 1 illustrates a block diagram of an embodiment of a development VM environment 100. After a user access a proxy to create a project and chooses a development environment with the hardware configuration (number of CPUs, GPUs, required RAM and storage memory, etc.), the user/client can send a command to TDE (102) to:
1. Launch a virtual machine (105) from the list of supported providers. VMD (103) gets the request and initiates VM instance creation (105).
2. Once the instance (105) is launched, VMD (103) establishes a Secure Shell (ssh) connection to a VM (105) and uploads the environment data with a boot up script that starts a docker image with Jupyter Notebook or Lab plugin, which is used as a development tool for end users.
3. Jupyter web interface is shown to the users, where they can write the model's code, run data preparation, augmentation, feature extraction, training and verify the prediction.
4. At any time, users may choose to save the project into MAS (106).
5. Users can also upload their own data (109) needed for training. That includes datasets and required packages. The process can be repeated as needed until development is finished and ready to be trained with the protected data.

FIG. 2 illustrates a block diagram of an embodiment of a data augmentation VM environment 200. Note that data augmentation may be optional and can be combined with a secure training illustrated in FIG. 3. Users may choose to run a separate process if the data preparation step requires a long time. The rationale may be for efficiency purposes. For example, data augmentation VMs may not require the presence of GPUs, which saves resources. Once a user's model is stored in MAS (206), they may want to, e.g., launch VM(s) (205) to perform data augmentation. VMD (203) gets the request and initiates VM instance(s) (205) creation. Once the instance (205) is launched, VMD (203) establishes a ssh connection with the VM (205) and uploads the environment data with a boot up script that starts a docker image with MME (205). After data augmentation is finished, the user script may save augmented data using TDE API, which saves the data into MAS (206).

FIG. 3 illustrates a block diagram of an embodiment of a secure training VM environment 300. When an initial development is finished and a user's model is stored in MAS (306), users can start a training process with secured access to the protected data (310) provided by PDAC's (304) protected data reader. VMD gets the request and initiates VM instance(s) creation (305). Once the instance is launched (305), VMD (303) establishes a ssh connection with the VM (305) and uploads the environment data with a boot up script that starts a docker image with MME (305). While training, the user's script may report its training statistics to TM (Training Monitor), which is securely forwarded to CDC (301) in the form of visual graphics (PNG files) to eliminate the security threat of compromising relevant data from the dataset (310). After the training process is finished, the user script should save the model's weights coefficients using TDE API, which forwards the data into MAS (306).

FIG. 4 illustrates a block diagram of an embodiment of a production deployment VM environment 400. When secure training as illustrated in FIG. 3 is finished, users can start a production deployment process 400 illustrated in FIG. 4. VMD 403 gets the request from the users and initiates VM instance(s) creation (405). Once the instance is launched, VMD (403) establishes a ssh connection with VM instance(s) and uploads the environment data with a boot up script that starts a docker image with MME (405). MME (405) accesses MAS (406) via the PDAC (404) and loads trained models for the production run.

FIG. 5 illustrates a block diagram of an embodiment of a prediction VM environment 400. When a production deployment environment is launched as illustrated in FIG. 4, a user application (501) can send prediction requests to a public URL in a specified format through a public network (510). This public URL is previously allocated by TDE and serves as an access point to the trained model by client applications (510). Network Load Balancer (520) decides which VM is to be used for the inference and then forwards the request to a specific VM of the multiple VMs (505). User model (505) running within the production deployment environment gets an internal API call to run the prediction as one atomic sequential operation. When the result is ready, model prediction is wrapped in JSON format and is sent back to the client application (501).

Present principles may be implemented into products for data science groups, research organizations, educational institutions or companies working on data science projects requiring access to the proprietary data outside of the public domain. The prime target groups for present practical applications and improvements are, e.g., research groups and institutions in medical services, although it can be easily extended to fields of use, including but not limited to engineering and other technical or scientific fields or applications.

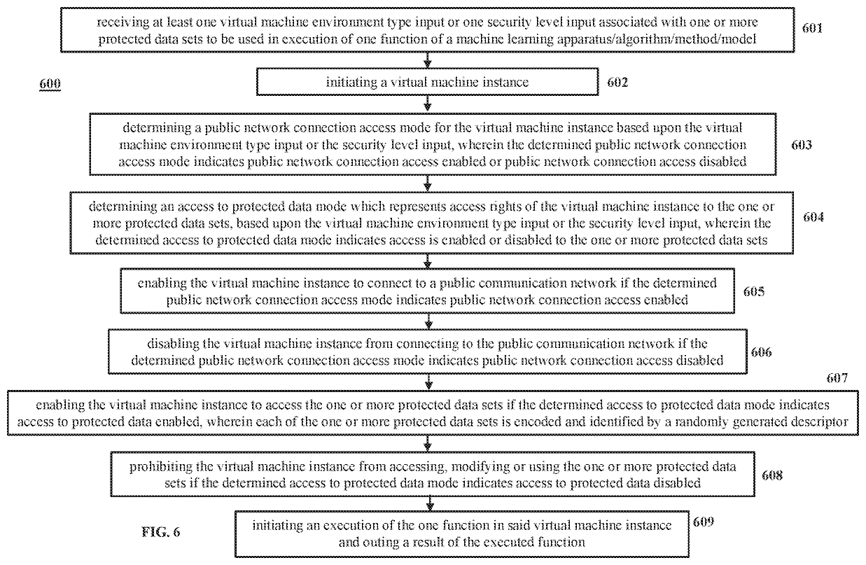

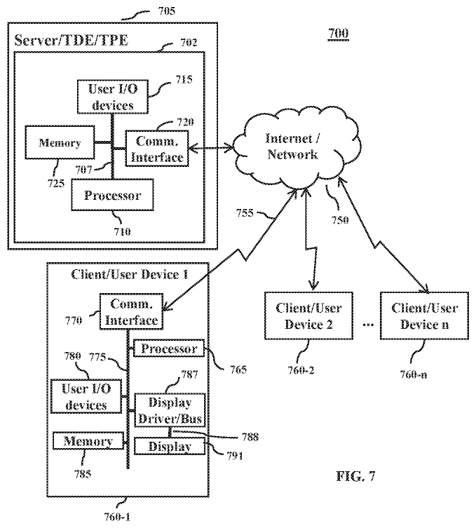

Accordingly, FIG. 6 illustrates an exemplary process 600 according to the present embodiments. At 601, an apparatus such as, e.g., server 702 shown in FIG. 7 and to be described below, receives at least one virtual machine environment type input or one security level input associated with one or more protected data sets to be used in execution of one function of a machine learning apparatus/algorithm/method/model. At 602, sever 702 initiates a virtual machine instance. At 603, server 702 determines a public network connection access mode for the virtual machine instance based upon the virtual machine environment type input or the security level input, wherein the determined public network connection access mode indicates public network connection access enabled or public network connection access disabled. At 604, server 702 determines an access to protected data mode which represents access rights of the virtual machine instance to the one or more protected data sets, based upon the virtual machine environment type input or the security level input, wherein the determined access to protected data mode indicates access is enabled or disable to the one or more protected data sets.

Continuing at 605 of FIG. 6, server 702 enables the virtual machine instance to connect to a public communication network if the determined public network connection access mode indicates public network connection access enabled. At 606, server 702 disables the virtual machine instance from connecting to the public communication network if the determined public network connection access mode indicates public network connection access disabled. At 607, server 702 enables the virtual machine instance to access the one or more protected data sets if the determined access to protected data mode indicates access to protected data enabled, wherein each of the one or more protected data sets is encoded and identified by a randomly generated descriptor. At 608, server 702 prohibits the virtual machine instance from accessing, modifying or using the one or more protected data sets if the determined access to protected data mode indicates access to protected data disabled. At 609, server 702 initiates an execution of the one function in said virtual machine instance and outing a result of the executed function.

FIG. 7 shows an exemplary system 700 according to the present principles. The exemplary system 700 in FIG. 7 comprises a server 702 located at a server location 705 according to the present principles. Server 702 may implement, e.g., the functions of TDE or TPE as described above and provide the various VM instances as needed according to the present embodiments. For example, server 702 is capable of receiving and processing client/user requests (e.g., API requests) from one or more of client/user devices 760-1 to 760-n. The server 702, in response to the client/user requests, may provide relevant responses to the client/user devices 760-1 to 760-n for secure machine training and/or deployment purposes.

Various exemplary client/user devices 760-1 to 760-n in FIG. 7 may communicate with the server 702 over a communication network 750 such as, e.g., the internet, a wide area network (WAN), and/or a local area network (LAN). Server 702 may communicate with client/user devices 760-1 to 760-n in order, e.g., to process and receive pertinent information regarding to a training process such as illustrated in FIG. 6 and as already described before.

Server 702 shown in FIG. 7 may represent and be implemented as a dedicated server or as part of a cloud computing platform, and/or the server may be implemented in a centralized or distributed environment. Also, sever 702 may be implemented as a single server or a cluster of servers. As an example, server 702 may be a computer having (or a cluster of computers each having) a processor 710 such as, e.g., an Intel processor, running an appropriate operating system such as, e.g., Windows Server, Linux operating system, and etc.

Client/user devices 760-1 to 760-n shown in FIG. 7 may be one or more of, e.g., a computer, a PC, a laptop, a tablet, or a cellphone. Examples of such devices may be, e.g., a Microsoft Windows or Mac OA computer/tablet, an Android phone/tablet, an Apple IOS phone/tablet, another kind of processing device, or the like. A detailed block diagram of an exemplary client device according to the present principles is illustrated in block 760-1 of FIG. 7 as Device 1 and will be further described below.

An exemplary client/user device 760-1 in FIG. 1 comprises a processor 765 for processing various data and for controlling various functions and components of the device 760-1. The processor 765 communicates with and controls the various functions and components of the device 760-1 via a control bus 775 as shown in FIG. 7. For example, the processor 765 provides processing of various web data and content to be accessed and displayed on the client devices 760-1 to 760-n.

Device 760-1 may also comprise a display 791 which is driven by a display driver/bus component 787 under the control of processor 765 via a display bus 788 as shown in FIG. 7. In additional, exemplary device 760-1 in FIG. 7 may also comprise various user input/output (UO) devices 780. The client interface devices 780 of the exemplary device 760-1 may represent e.g., a mouse, touch screen capabilities of a display (e.g., display 791), a touch and/or a physical keyboard. The user interface devices 780 of the exemplary device 760-1 may also comprise a speaker or speakers, and/or other indicator devices, for outputting visual and/or audio sound, user data and feedback.

Exemplary device 760-1 also comprises a memory 785 which may represent both a transitory memory such as RAM, and a non-transitory memory such as a ROM, a hard drive, a CD drive, a Blu-ray drive, and/or a flash memory, for processing and storing different files and information as necessary, including computer program products and software, webpages, user interface information, various databases, and etc., as needed. In addition, device 760-1 also comprises a communication interface 770 for connecting and communicating to/from server 702 and/or other devices, via, e.g., the network 750 using a link 755 representing, e.g., a connection through a cable network, a FIOS network, a Wi-Fi network, and/or a cellphone network (e.g., 3G, 4G, LTE, 5G), and etc.

According to the present principles, client/user devices 760-1 to 760-n in FIG. 7 may access, if applicable, different computing programs, user interface screens, web pages, services or databases provided by server 705 using, e.g., HTTP protocol. A well-known web server software application which may be run by server 705 to provide web pages is Apache HTTP Server software available from http://www.apache.org.

Turning to further detail of server 705 of FIG. 7, the server 705 may comprise a processor 710 which controls the various functions and components of the server 705 via a control bus 707 as shown in FIG. 7. In addition, a server administrator may interact with and configure server 105 to run different applications using different user input/output (I/O) devices 715 (e.g., a keyboard and/or a display) as well known in the art. Server 705 also comprises a memory 725 which may represent both a transitory memory such as RAM, and a non-transitory memory such as a ROM, a hard drive, a CD drive, a Blu-ray drive, and/or a flash memory, for processing and storing different files and information as necessary, including computer program products and software (e.g., as represented by a flow chart diagram of FIG. 6 already described above), webpages, user interface information, user account information, databases, search engine software, and/or algorithm(s). Databases may be stored in the non-transitory memory 725 of sever 705 as necessary, so that e.g., various client/user account related information may be stored.

In addition, server 705 is connected to network 750 through a communication interface 720 for communicating with other servers or web sites (not shown) and one or more client devices 760-1 to 760-n, as shown in FIG. 7. In addition, one skilled in the art would readily appreciate that other well-known server components, such as, e.g., power supplies, cooling fans, etc., may also be needed, but are not shown in FIG. 7 to simplify the drawing.

According to the present principles, an exemplary server 702 may be used to implement the various VM environments such as, e.g., TDE and/or TPE environments as shown in FIG. 1 to FIG. 5 as already described above. Persons skilled in the art will appreciate that numerous variations and modifications will become apparent. All such variations and modifications which become apparent to persons skilled in the art, should be considered to fall within the spirit and scope that the invention broadly appears before described.

The implementations and aspects described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus, for example, a processor, which refers to processing devices in general, including, for example, a computer, a microprocessor, an integrated circuit, or a programmable logic device. Processors also include communication devices, for example, computers, cell phones, portable/personal digital assistants (“PDAs”), and other devices that facilitate communication of information between end-clients.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment. Additionally, this application may refer to “determining” various pieces of information. Determining the information may include one or more of, for example, estimating the information, calculating the information, predicting the information, or retrieving the information from memory.

Further, this application may refer to “accessing” various pieces of information. Accessing the information may include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information may include one or more of, for example, accessing the information, or retrieving the information (for example, from memory). Further, “receiving” is typically involved, in one way or another, during operations, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

As will be evident to one of ordinary skill in the art, implementations may produce a variety of signals formatted to carry information that may be, for example, stored or transmitted. The information may include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

Additionally, one or more of the present embodiments provide a computer program comprising instructions which when executed by one or more processors cause the one or more processors to perform the encoding method or decoding method according to any of the embodiments described above. One or more of the present embodiments also provide a computer readable storage medium having stored thereon instructions for encoding or decoding video data according to the methods described above. One or more embodiments also provide a computer readable storage medium having stored thereon a bitstream generated according to the methods described above. One or more embodiments also provide a method and apparatus for transmitting or receiving the bitstream generated according to the methods described above.

1. A method comprising:
receiving, by an apparatus, at least one virtual machine environment type input or one security level input associated with one or more protected data sets to be used in execution of one function of a machine learning system;
initiating, by the apparatus, a virtual machine instance;
determining, by the apparatus, a public network connection access mode for the virtual machine instance based upon the virtual machine environment type input or the security level input, wherein the determined public network connection access mode indicates public network connection access enabled or public network connection access disabled;
determining, by the apparatus, an access to protected data mode which represents access rights of the virtual machine instance to the one or more protected data sets, based upon the virtual machine environment type input or the security level input, wherein the determined access to protected data mode indicates access is enabled or disabled to the one or more protected data sets;
enabling, by the apparatus, the virtual machine instance to connect to a public communication network if the determined public network connection access mode indicates public network connection access enabled;
disabling, by the apparatus, the virtual machine instance from connecting to the public communication network if the determined public network connection access mode indicates public network connection access disabled;
enabling, by the apparatus, the virtual machine instance to access the one or more protected data sets if the determined access to protected data mode indicates access to protected data enabled, wherein each of the one or more protected data sets is encoded and identified by a randomly generated descriptor;
prohibiting, by the apparatus, the virtual machine instance from accessing, modifying or using the one or more protected data sets if the determined access to protected data mode indicates access to protected data disabled; and
initiating, by the apparatus, an execution of the one function in said virtual machine instance and outing a result of the executed function.

2. An apparatus comprising:
at least one processor; and
at least one memory for storing computer program code which when executed by the at least one processor, cause the apparatus to:
encode one or more protected data sets and assign a randomly generated descriptor to identify each of the one or more protected data sets;
store the one or more protected data sets in the at least one memory;
receive at least one virtual machine environment type input or one security level input associated with the one or more data sets to be used in execution of one function of a machine learning system;
initiate a virtual machine instance;
determine a public network connection access mode for the virtual machine instance based upon the virtual machine environment type input or the security level input, wherein the determined public network connection access mode indicates public network connection access enabled or public network connection access disabled;
determine an access to protected data mode which represents access rights of said virtual machine instance to the one or more protected data sets, based upon the virtual machine environment type input or the security level input, wherein said determined access to protected data mode indicates access is enable or disabled to the one or more protected data sets;
enable the virtual machine instance to connect to a public communication network if the determined public network connection access mode indicates public network connection access enabled;
disable the virtual machine instance from connecting to the public communication network if the determined public network connection access mode indicates public network connection access disabled;
enable the virtual machine instance to access the one or more protected data sets if the determined access to protected data mode indicates access to protected data enabled, wherein each of the one or more protected data sets is encoded and identified by a randomly generated descriptor;
prohibit the virtual machine instance from accessing, modifying or using the one or more protected data sets if the determined access to protected data mode indicates access to protected data disabled; and
initiate an execution of the one function in said virtual machine instance and outing a result of the executed function.

3. An apparatus comprising:
at least one processor; and
at least one memory for storing computer program code which when executed by the at least one processor, configured the apparatus to:
receive, by the apparatus, a virtual machine environment type input; and
create, by the apparatus, a virtual machine based on the virtual machine environment type input, wherein the virtual machine permits access to one or more training data sets for training a machine learning system if the virtual machine environment type input indicates access to data enabled mode, and wherein the virtual machine prohibits the access to the one or more training data sets for training the machine learning system if the virtual machine environment type input indicates access to data disabled mode.

4. The apparatus of claim 3, wherein the apparatus is further configured to:
permit a connection to a communication network if the virtual machine environment type input indicates a connection access enabled mode; and
prohibit the connection to the communication network if the virtual machine environment type input indicates a connection access disabled mode.

5. The apparatus of claim 4, wherein the virtual machine environment type input is dependent on an input by a user.

6. The apparatus of claim 5, wherein the input is an application user interface command input by the user remotely.

7. The apparatus of claim 6, wherein virtual machine environment type input indicates a prediction virtual machine environment and permitting the virtual machine access to the one or more training data sets for the training of the machine learning system.

8. The apparatus of claim 7, wherein the virtual machine environment type input indicates a connection access disabled mode that prohibits the connection to the communication network when the virtual machine is accessing the one or more training data sets for the training of the machine learning system.

9. The apparatus of claim 8, wherein the application user interface command is inputted by the user via a secure proxy.

10. The apparatus of claim 9, wherein the application user interface command is a http command.

11. A method comprising:
receiving, by an apparatus, a virtual machine environment type input; and
creating, by the apparatus, a virtual machine based on the virtual machine environment type input, wherein the virtual machine permits access to one or more training data sets for training a machine learning system if the virtual machine environment type input indicates access to data enabled mode, and wherein the virtual machine prohibits the access to the one or more training data sets for training the machine learning system if the virtual machine environment type input indicates access to data disabled mode.

12. The method of claim 11, further comprising:
permitting a connection to a communication network if the virtual machine environment type input indicates a connection access enabled mode; and
prohibiting the connection to the communication network if the virtual machine environment type input indicates a connection access disabled mode.

13. The method of claim 12, wherein the virtual machine environment type input is dependent on an input by a user.

14. The method of claim 13, wherein the input is an application user interface command input by the user remotely.

15. The method of claim 14, wherein the virtual machine environment type indicates a prediction virtual machine environment and permitting the virtual machine access to the one or more training data sets for the training of the machine learning system.

16. The method of claim 15, wherein the virtual machine environment type input indicates a connection access disabled mode that prohibits the connection to the communication network when the virtual machine is accessing the one or more training data sets for the training of the machine learning system.

17. The method of claim 16, wherein the application user interface command is inputted by the user via a secure proxy.

18. The method of claim 17, wherein the application user interface command is a http command.
